(19) United States
(12) Patent Application Publication
(10) Pub. No.: US 2022/0229422 A1
(43) Pub. Date: Jul. 21, 2022

(54) INFORMATION GENERATION DEVICE, INFORMATION GENERATION METHOD, AND NON-TRANSITORY COMPUTER-READABLE RECORDING MEDIUM

(71) Applicant: Mitsubishi Electric Corporation, Tokyo (JP)

(72) Inventors: Satoshi NOGUCHI, Tokyo (JP); Shohei IIJIMA, Tokyo (JP); Yuya OTAKE, Tokyo (JP)

(73) Assignee: Mitsubishi Electric Corporation, Tokyo (JP)

(21) Appl. No.: 17/714,488

(22) Filed: Apr. 6, 2022

Related U.S. Application Data
(63) Continuation of application No. PCT/JP2019/046940, filed on Dec. 2, 2019.

(51) Int. Cl. G05B 19/418

(52) U.S. Cl. CPC G05B 19/4185; G05B 19/4183; G05B 19/4188

(57) ABSTRACT

An information generation device (100) includes: a communication mediation unit (110) to mediate communication between a facility and management software that manages the facility; a data management unit (120) to store information including a facility type of the facility and a name of data of the facility, as management information to correspond to the facility, the name of data of the facility being used by the management software, and to update the stored management information on a basis of communication mediated by the communication mediation unit (110); and an update notification unit (130) to generate update information corresponding to update data, when the management information stored in the data management unit (120) is updated, if same-type facility data corresponding to a facility of a same type as a facility corresponding to the update data that is updated is stored in the data management unit (120).

### CROSS REFERENCE TO RELATED APPLICATIONS

This application is a Continuation of PCT International Application No. PCT/JP2019/046940 filed on Dec. 2, 2019, which is hereby expressly incorporated by reference into the present application.

### TECHNICAL FIELD

The present invention relates to an information generation device, an information generation method, and an information generation program.

### BACKGROUND ART

In recent years, factories often introduce IT systems and the like in order to perform monitoring, control, management, and so on of manufacturing facilities, and technological development for introducing the IT systems efficiently or effectively has been under way. As part of this development, a platform has been developed and used that mediates between software and a manufacturing facility and collectively manages data of the manufacturing facility, so that the software can handle the data of the manufacturing facility easily.

In response to a conventional demand for collective management of data used by various software, Patent Literature 1 discloses a technique that allows collective viewing of plant data collected by different software. Further, Patent Literature 2 discloses a technique that standardizes structures of data managed by different production management systems according to types of businesses, so that one system can easily use data of another system.

### CITATION LIST

### Patent Literature

Patent Literature 1: JP 4808407 B2
Patent Literature 2: JP 2000-137504 A

### SUMMARY OF INVENTION

### Technical Problem

When there is a need to manufacture many products in a factory, generally, a plurality of facilities such as similar devices, similar manufacturing lines, and similar facilities are prepared, and products are manufactured in a parallel manner. In such a case, if certain management software was applied to a certain facility and some effect was obtained, the same effect can be expected in another similar facility if that management software is deployed. However, even with another facility of the same type, it is difficult to share information if, for example, managers are different, factories are at remote locations, and so on. This leads to a problem that it is difficult for a manager of a certain facility to grasp what kind of management software is installed in a facility of the same type and what kind of data is used by the management software.

According to conventional technique, information of all factories can be displayed collectively. However, especially when there are a large number of pieces of data, it is difficult for the manager to determine which data can be exploited in the facility managed by the manager.

An objective of the present invention is to enable a manager of a certain facility, in a case where there is a change to management software installed in a facility of the same type as the certain facility, or in a case where there is a change to data used by the management software, to know a content of the change relatively easily.

### Solution to Problem

An information generation device of the present invention includes:

a communication mediation unit to mediate communication between a facility and management software that manages the facility;

a data management unit to update management information that is stored, on a basis of communication mediated by the communication mediation unit, wherein information including a facility type of the facility and a management data name is stored in the data management unit as the management information to correspond to the facility, the management data name being a name of data of the facility and being used for the management software to manage the facility; and

an update notification unit to generate update information corresponding to update data, when the management information stored in the data management unit is updated, if same-type facility data corresponding to a same-type facility is stored in the data management unit, the same-type facility being a facility of a same type as a facility corresponding to the update data that is updated.

### Advantageous Effects of Invention

According to the present invention,

a data management unit manages information of a facility and information of management software that manages the facility, to correspond to the facility, and

in a case where a manager of the facility introduces new management software in order to manage the facility, and/or in a case where the manager changes data dealt with by the management software, an update notification unit generates update information corresponding to the change so that a manager of a facility of the same type as the facility is able to know a content of the change relatively easily.

Therefore, according to the present invention, information can be generated that enables the manager of the certain facility, in a case where there is a change to management software installed in a facility of the same type as the certain facility, and/or in a case where there is a change to data used by the management software of the facility of the same type as the certain facility, to know a content of the change relatively easily.

### BRIEF DESCRIPTION OF DRAWINGS

FIG. 1 is a configuration diagram of an information generation device 100 according to Embodiment 1.

FIG. 2 is a hardware configuration diagram of the information generation device 100 according to Embodiment 1.

FIG. 3 is a configuration diagram of an information generation system 90 provided with the information generation device 100 according to Embodiment 1.

FIG. 4 presents an example of a data management table 121 according to Embodiment 1.

FIG. 5 presents an example of the data management table 121 according to Embodiment 1.

FIG. 6 is a flowchart illustrating operations of an update notification unit 130 according to Embodiment 1.

FIG. 7 is a flowchart illustrating operations of an update notification unit 130 according to a modification of Embodiment 1.

FIG. 8 is a configuration diagram of an information generation device 100 according to Embodiment 2.

FIG. 9 is a configuration diagram of an information generation system 90 provided with the information generation device 100 according to Embodiment 2.

FIG. 10 is a flowchart illustrating operations of the information generation device 100 according to Embodiment 2.

FIG. 11 presents an example of a data management table 121 according to Embodiment 2.

### DESCRIPTION OF EMBODIMENTS

### Embodiment 1

An embodiment of the present invention will be described below in detail with referring to drawings.

***Description of Configurations***

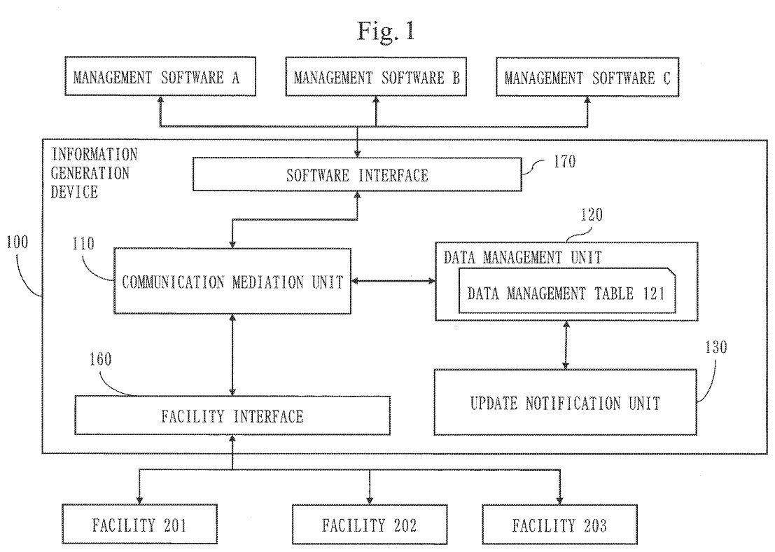

FIG. 1 is a diagram illustrating a configuration example of an information generation system 90 provided with an information generation device 100 according to the present embodiment.

As illustrated in FIG. 1, the information generation device 100 is provided with a communication mediation unit 110, a data management unit 120, an update notification unit 130, a facility interface 160, and a software interface 170. The information generation device 100 is connected to management software so that it can communicate with a facility.

In FIG. 1, management software A manages a facility 201, management software B manages a facility 202, and management software C manages a facility 203. There may be any number of pieces of management software and any number of facilities.

The management software is software that can manage the facility. Specific examples of the management software are software that has a function of deciding control of the facility on the basis of data received from the facility and transmitting the decided control to the facility, and software that monitors a state of the facility.

The facility is a facility that can communicate with the information generation device 100, and is not limited to a facility that manufactures products.

A manager is at least one person who manages at least one facility and need not be a human; it can be, for example, a computer. When there are a plurality of managers for one facility, each manager need not necessarily cover entire management of the facility.

The communication mediation unit 110 manages setting concerning data communication between the facility and the management software as communication setting, and mediates data communication between the facility and the management software.

The manager can perform communication setting.

The information generation system 90 may be configured such that the manager can perform communication setting via the management software and/or the facility. The information generation system 90 may be configured such that the manager can perform communication setting by operating the information generation device 100 directly.

A specific example of a procedure of performing communication setting will be explained. The communication mediation unit 110 receives, from the facility, a facility data list which is a list of data that can be communicated between the management software and the facility, and a communication method of each data in the facility data list, and transmits the facility data list to the management software. The management software discloses the facility data list to the manger. The manager selects, from the facility data list, data to be included in the management data list that lists data to be transmitted to the manager by the management software. The management software transmits the management data list to the information generation device 100. The information generation device 100 performs communication setting on the basis of the data indicated by the management data list and a communication method of the data indicated by each management data list.

The manager may select data from the facility data list piece by piece manually, or may select data with utilizing a data file that describes input/output information of the facility, as in setting in CSP+ for Machine (registered trademark, Control & Communication System Profile Plus) (see Reference Literature 1).

### Reference Literature 1

“CSP+ for Machine”, [online], CC-Link organization, [searched on Oct. 28, 2019], Internet <URL: https://www.cc-link.org/ja/cclink/cspplus m/index.html>

If the management software can acquire the facility data list because, for example, the facility data list has been disclosed, the communication mediation unit 110 need not transmit the facility data list to the management software. The communication mediation unit 110 need not accept the management data list from the management software.

The communication mediation unit 110 manages data communication between the facility and the software according to communication setting.

The facility interface 160 is an interface for the information generation device 100 to communicate with the facility. The information generation device 100 communicates with the facility. In a specific example, the information generation device 100 may communicate with the facility by Ethernet (registered trademark) or serial communication. The information generation device 100 may be incorporated in one facility so that data can be transferred without using a communication cable or the like. A communication protocol of the facility interface 160 may be a common communication protocol such as Open Platform Communications-Unified Architecture (OPC-UA), or may be an original protocol. The facility interface 160 may be able to cope with a plurality of communication protocols simultaneously.

In the following, when referring to an interface for communication, the same discussion as for the facility interface 160 applies unless otherwise noted.

The software interface 170 is an interface required for communication between the information generation device 100 and the management software.

The information generation device 100 may be provided with management software. Hardware different from the information generation device 100 may be provided with management software.

Data concerning data communication mediated by the communication mediation unit 110 is stored in the data management unit 120 as management information. The data management unit 120 manages the management information to correspond to the facility. Typically, the management information includes a type of the facility and a management data name which is a name of data of the facility. In a specific example, the management information is a data management table 121.

The data management unit 120 manages specifically information concerning between which facility and which management software communication is established, a management data name used by the management software, a facility type expressing the type of the facility, and so on, on the basis of the data management table 121 that manages the data. The management data is facility data that the management software employs to manage the facility.

The data management unit 120 may set the data management table 121 when the communication mediation unit 110 performs communication setting, or may set the data management table 121 by monitoring each communication interface and grasping a content of communication between the management software and the facility. The facility type is a stipulation for classifying the facility. In a specific example, a facility may be classified according to its function such as a processing device and a conveyor, or the facility may be classified according to a model name of a device that constitutes the facility. The facility type may be set by stipulating an original naming rule, or by standardizing a type representation just like product classification of eCl@ss and by utilizing the standardized type representation.

When the communication mediation unit 110 receives the management data list, the data management unit 120 sets the data management table 121 on the basis of the management data list. The data management unit 120 may use a data management table 121 prepared by the manager.

In a specific example, the data management table 121 may perform hierarchical management by treating a “manufacturing line A” as a first hierarchical rank, and a “device α” and a “device β” as a second hierarchical rank. This management example will be referred to as a “management method A” hereinafter. Note that “device α” and “device β” are names of facilities, and that “manufacturing line A” is a name of a group consisting of “device α” and “device β”.

When management data used by certain management software to manage a certain facility (to be referred to as facility A hereinafter) is updated, the update notification unit 130 generates update information notifying that the data management table 121 is updated, and notifies the update information to a manager of another facility of the same type as the facility A. The update notification unit 130 determines whether or not another facility is a facility of the same type as the facility A on the basis of the data management table 121. Referring to the example of FIG. 1, in a specific example, the certain management software is management software A, and the facility A is the facility 201.

In the update notification unit 130, a manager of each facility, and a notification means, per manager, for notification to the manager are stored. The notification means is a means for notifying the manager of the update information.

In a specific example, the update notification unit 130 may register an email address of the manager of each facility, and when data to be used in a facility of the same type is added, may notify this addition at once by email. The update notification unit 130 may output an instruction to display the update information to a display or the like connected to the information generation device 100.

The update notification unit 130 may receive an inquiry from the manager and notify, to the manager, information including a difference from the last inquiry, change of time, and so on in response to the received inquiry.

Regarding the notification, only a combination of the facility and the management data may be notified, or information including a name of the software which uses the management data, the type of facility, and so on may be notified. In a case where the data management unit 120 manages the facility as in, for example, the “management method A”, when management data of either one of the “device α” and the “device β” included in the manufacturing line A is changed, the update information is notified to the manager who manages a line of the same type as the manufacturing line A.

The update notification unit 130 may judge anyhow whether a plurality of types of different facilities are of the same type or not. Even when the types of the facilities are different, the update notification unit 130 may consider the plurality of types of different facilities as being of the same type if the types are similar.

The information generation device 100 may be built in a cloud environment, in a computer in a factory, or in a computer that controls the facility.

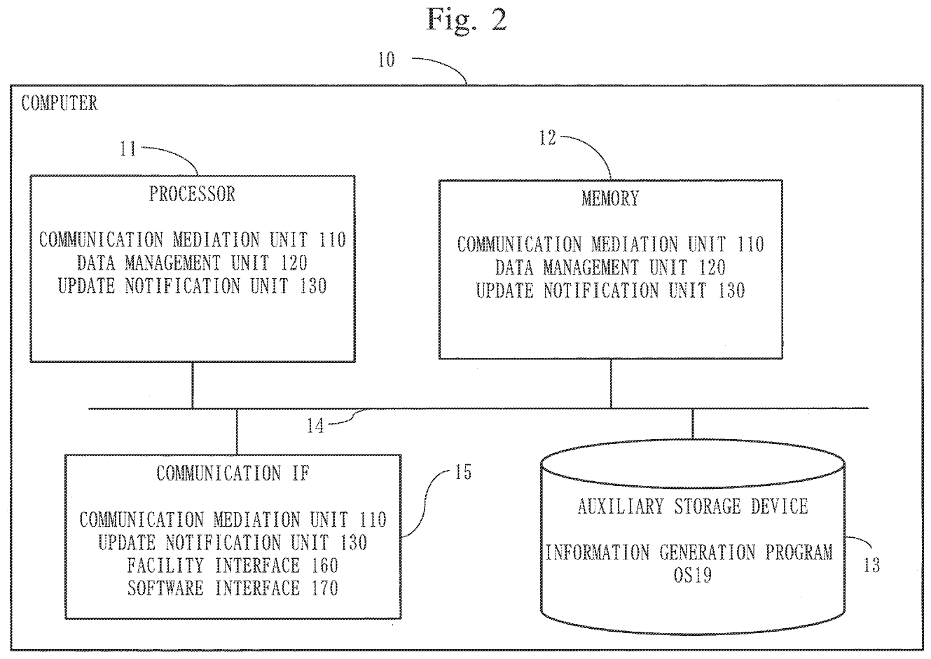

FIG. 2 presents a hardware configuration example of the information generation device 100. The information generation device 100 is formed of a common computer 10.

A processor 11 is a processing device that runs an information generation program, an Operating System (OS) 19, and so on. The processing device is sometimes called an Integrated Circuit (IC). Specific examples of the processor 11 are a Central Processing Unit (CPU), a Digital Signal Processor (DSP), and a Graphics Processing Unit (GPU).

The processor 11 is connected to a memory 12 via a data bus 14. The processor 11 temporarily stores data necessary for computation, and/or saves the data. The processor 11 reads a program stored in the memory 12 and runs the program.

The information generation device 100 of FIG. 2 is provided with only one processor 11. However, the information generation device 100 may be provided with a plurality of processors that substitute for the processor 11. The plurality of processors share running of the program, and so on.

The memory 12 is a storage device that stores data temporarily. The memory 12 can hold a computation result of the processor 11 and functions as a main memory used as a work area of the processor 11. The memory 12 can store programs corresponding to the communication mediation unit 110, data management unit 120, update notification unit 130, and so on. Processes stored in the memory 12 are deployed to the processor 11.

A specific example of the memory 12 is a Random-Access Memory (RAM) such as a Static Random-Access Memory (SRAM) and a Dynamic Random-Access Memory (DRAM).

The communication mediation unit 110, the data management unit 120, and the update notification unit 130 may be at least partly formed of an auxiliary storage device 13.

The auxiliary storage device 13 stores the information generation program, various types of programs which are run by the processor 11, data to be used when running the programs, the OS 19, and so on. A specific example of the auxiliary storage device 13 is a Hard Disk Drive (HDD) or a Solid-State Drive (SSD). The auxiliary storage device 13 may be a portable recording medium such as a memory card, a Secure Digital (registered trademark, SD) memory card, a Compact Flash (CF), a NAND flash, a flexible disk, an optical disk, a compact disk, a Blu-ray (registered trade mark) Disc, and a Digital Versatile Disk (DVD).

The information generation program may be provided as a program product.

A communication Interface (IF) 15 is an interface for the computer 10 to communicate data with another apparatus. A specific example of the communication IF 15 is an Ethernet (registered trademark) port or a Universal Serial Bus (USB) port. There may be a plurality of communication IFs 15.

The communication IF 15 implements functions of the communication mediation unit 110, update notification unit 130, facility interface, and software interface.

The OS 19 is loaded from the auxiliary storage device 13 by the processor 11, is deployed to the memory 12, and is run on the processor 11. The OS 19 may be of any type as far as it matches the processor 11.

The OS 19 and the information generation program may be stored in the memory 12.

***Description of Operations***

An operation procedure of the information generation device 100 corresponds to an information generation method. A program that implements operations of the information generation device 100 corresponds to the information generation program.

The operations of the information generation device 100 will now be described with referring to an example of embodiment.

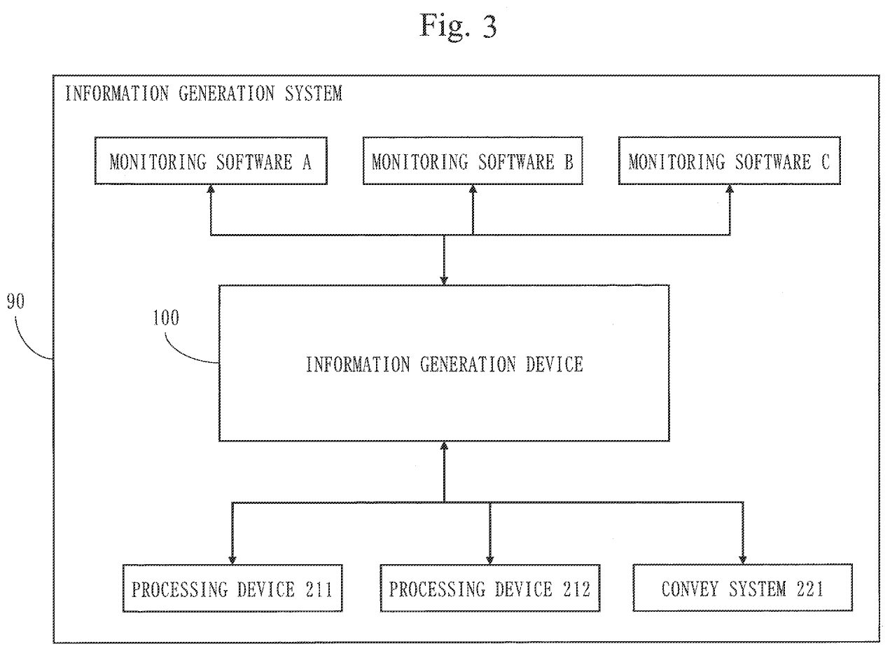

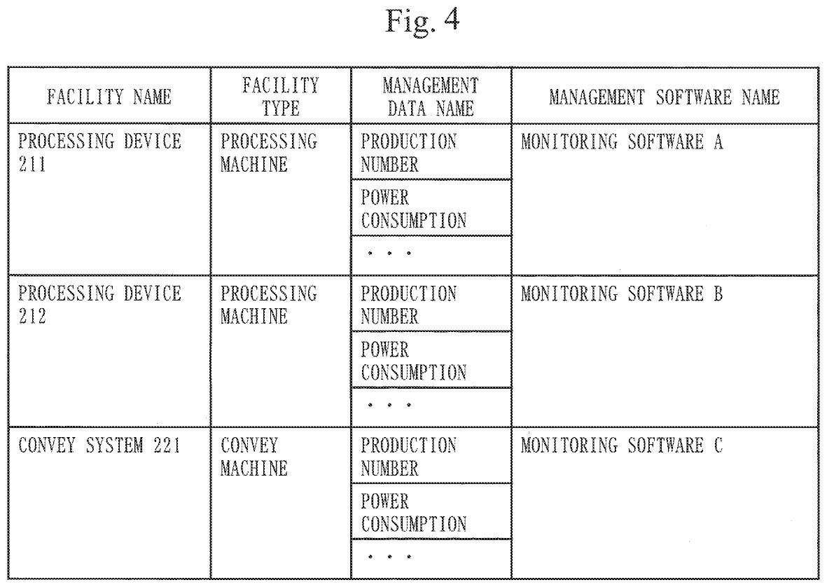

FIG. 3 presents an example of the information generation system 90 provided with the information generation device 100. Note that the information generation device 100 mediates communication between two processing devices and one convey system, and monitoring software A, B, and C which monitor the two processing devices and the one convey system, as illustrated in FIG. 3. In this example, the data management unit 120 manages facility name, facility type, management software name, and management data name, as illustrated in FIG. 4, the facility type expressing a type of the facility, the management software name being a name of the management software which manages the facility, the management data name being a name of the management data for the management software to manage the facility.

In the information generation system 90 of this example, a manager of a processing device 211 attaches a vibration sensor to the processing device 211 for the purpose of maintenance of the device and/or prediction of an abnormality, and so on. The manager installs, as the management software, analysis software which detects an abnormality by analyzing vibration data acquired by the vibration sensor. The manager sets the communication mediation unit 110 so as to acquire the vibration data of the processing device 211. The manager sets the analysis software so as to analyze the vibration data.

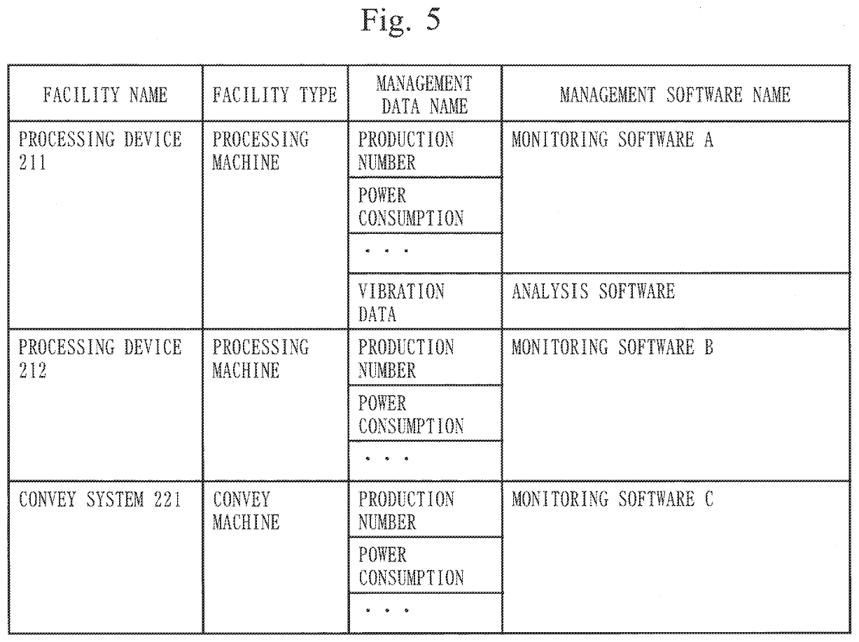

The data management unit 120 takes a grasp of a content of communication between the processing device 211 and the analysis software via the communication mediation unit 110, thereby updating the data management table 121 as illustrated in FIG. 5.

The update notification unit 130 detects that the data management table 121 of the data management unit 120 is updated, and generates update information.

When a predetermined condition is satisfied, the update notification unit 130 generates update information including information of a “processing device 212”, information of the “vibration data”, and information of the “analysis software”. In a specific example, the update notification unit 130 notifies the update information to the manager of the processing device 212 by email. Alternatively, when the manager requests a list of update data of the processing device 212 from the update notification unit 130, the update notification unit 130 displays the update information onto the display or the like.

At this time, typically, the update notification unit 130 does not notify the update information to a manager of a convey system 221. However, the manager may enter, as the facility type, a factory line or the like including a processing device and a convey system. Then, if, for example, the manager of the convey system wishes to know how the processing device operates, the update notification unit 130 can notify the update information of the processing device to the manager of the convey system as well. The update notification unit 130 may be set such that it does not always notify the update information when the data management table 121 is updated. For example, the update notification unit 130 may be set to compare update information generated by the update notification unit 130 with update information that has already been notified to the manager. If the two pieces of information are the same, the update notification unit 130 may judge that the update information has already been notified, and does not notify the update information.

When the update notification unit 130 detects that data of a plurality of facilities are updated, typically the update notification unit 130 generates update information of each of all facilities whose update has been detected, and notifies the update information of each facility to the manager of a facility of the same type.

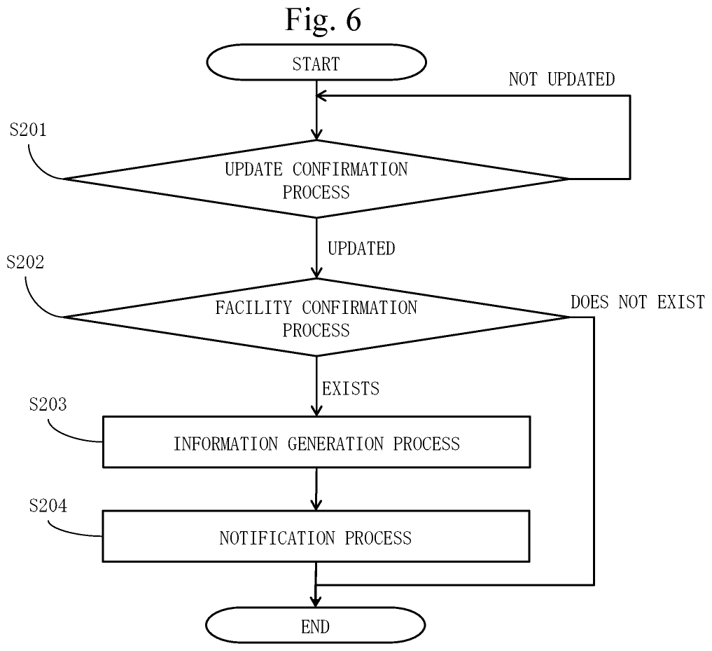

FIG. 6 is a flowchart illustrating an example of operations of the update notification unit 130 to judge whether or not to execute an update information generation process.

The update notification unit 130 typically executes processing of this flowchart regularly.

(Step S201: Update Confirmation Process)

Upon detection of update of the data management table 121, the update notification unit 130 proceeds to step S202; otherwise, continues the processing of this flowchart.

Data corresponding to the detected update will be referred to as update data.

(Step S202: Facility Confirmation Process)

On the basis of the data management table 121, the update notification unit 130 confirms whether there exists in the information generation system 90 a facility of the same type (to be referred to as the same-type facility hereinafter) as a facility corresponding to the update data. That is, the update notification unit 130 confirms whether the data management unit 120 stores same-type facility data.

The same-type facility data is data corresponding to the same-type facility which is a facility of the same type as the facility corresponding to the update data.

If the same-type facility exists, the update notification unit 130 proceeds to step S203; otherwise, ends the processing of this flowchart.

(Step S203: Information Generation Process)

The update notification unit 130 generates update information corresponding to the update data.

This is because the update information can be helpful if the data corresponding to the same-type facility does not include update data.

(Step S204: Notification Process)

The update notification unit 130 notifies the update information to the manager of the same-type facility.

### Feature of Embodiment 1

The information generation device 100 is provided with the communication mediation unit 110, the data management unit 120, and the update notification unit 130. The communication mediation unit 110 mediates communication between a facility and management software that manages the facility. The data management unit 120 stores information including a facility type of the facility and a management data name, as the management information to correspond to the facility. The management data name is a name of data of the facility and is used for the management software to manage the facility. The data management unit 120 updates the stored management information on the basis of communication mediated by the communication mediation unit 110. The update notification unit 130 generates update information corresponding to update data, when the management information stored in the data management unit 120 is updated, if same-type facility data corresponding to a same-type facility is stored in the data management unit 120, the same-type facility being a facility of the same type as a facility corresponding to the update data that is updated.

Information of a manager of a facility is stored in the update notification unit 130 to correspond to the facility, and the update notification unit 130 notifies the update information to a manager of the same-type facility.

A notification means for notification to the manager is stored, per manager, in the update notification unit 130. The update notification unit 130 notifies the update information to the manager of the same-type facility according to the notification means.

The data management unit 120 manages the management information with using the data management table 121.

Information of the management software is stored in data management unit 120, as being included in the management information.

### Description of Effect of Embodiment 1

As described above, according to the present embodiment, when the management software and/or data of a facility handled by the management software is changed, as in a case where new data of the facility handled by the management software is added, the update notification unit 130 generates update information corresponding to a content of change, and notifies the generated update information to a manager of another facility of the same type.

Therefore, according to the present embodiment, for a manager of a certain facility, in a case where there is a change to management software installed in a facility of the same type as the certain facility, and/or in a case where there is a change to data used by the management software, the manager of the certain facility is able to know a content of change relatively easily.

<Modification 1>

The information generation device 100 may be formed of a plurality of computers.

<Modification 2>

In the information generation system 90, one piece of software may manage a plurality of facilities.

<Modification 3>

The data management unit 120 may use a plurality of data management tables 121.

In the present modification, the data management unit 120 stores a plurality of data management tables 121.

<Modification 4>

The data management unit 120 may manage a plurality of facility types per facility.

According to the present modification, in a specific example, the data management unit 120 can manage a plurality of facility types per facility, in the facility type of the data management table 121.

In the present modification, the update notification unit 130 confirms in step S202 whether there exists in the information generation system 90 a facility which is of the same type as one type among facilities corresponding to the update data.

<Modification 5>

In a case where a plurality of managers manage one facility, the update notification unit 130 may notify update information to only some managers.

According to the present modification, assume a case of a specific example where a manager α and a manager β manage a certain facility with using management software A and management software B; the manager a is in charge of the management software A; and the manager β is in charge of the management software B. In this case, if there is a change to data used by the management software A, the update notification unit 130 may notify update information to only the manager α.

<Modification 6>

As a specific example, assume a case where a new processing device 213 is added to the information generation system 90 illustrated in FIG. 3 and a production number is set as management data of management software that manages the processing device 213. In this case, the update notification unit 130 might not as well notify update information concerning the production number to the manager of the processing device 211 in which a production number has already been set as management data, and to the manager of the processing device 212 in which a production number has already been as management data. Specifically, the update notification unit 130 performs processing as follows. For example, the update notification unit 130 judges whether a suite of management data and management software which are included in update data of the data management table 121 are included in data of a facility of the same type. If it is included, the update notification unit 130 does not notify the update information to that facility of the same type.

In a specific example, the update notification unit 130 may judge whether or not to perform notification by comparing character strings such as the data name and so on illustrated in FIG. 5, or may judge whether or not to perform notification by newly adding attribute information for comparison.

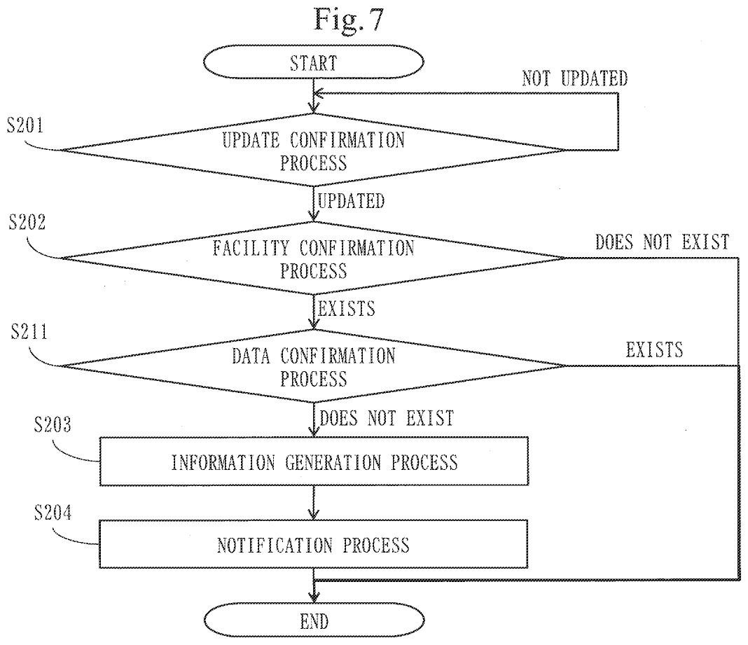

FIG. 7 is a flowchart illustrating an example of operations of the update notification unit 130 according to the present modification to judge whether or not to execute the update information generation process.

(Step S211: Data Confirmation Process)

In the table management data, if update data is not included in data corresponding to the same-type facility, the update notification unit 130 proceeds to step S203; otherwise, ends the processing of this flowchart.

If a suite of management data and management software which are the same as the suite included in the update data are not included in data corresponding to the same-type facility, the update notification unit 130 may judge that update data is not included in the data corresponding to the same-type facility.

***Feature of Present Modification***

If the update data is reflected in the same-type facility data, the update notification unit 130 does not notify the update information to the manager of the same-type facility.

<Modification 7>

The data management unit 120 may manage the type of the management data.

According to the present modification, in a specific example, the data management unit 120 manages the type of the management data by the data management table 121.

According to the present modification, in a process of step S211, if, on the data management table 121, management data of the same type as the management data included in the update data is not included in data corresponding to the same-type facility, the update notification unit 130 may proceed to step S203.

<Modification 8>

In the present embodiment, a case has been described where function constituent elements are implemented by software. However, in a modification, the function constituent elements may be implemented by hardware.

In a case where the function constituent elements are implemented by hardware, the information generation device 100 is provided with an electronic circuit 16 in place of a processor 11. Alternatively, although not illustrated, the information generation device 100 is provided with an electronic circuit 16 in place of a processor 11, a memory 12, and an auxiliary storage device 13. The electronic circuit 16 is a dedicated electronic circuit that implements functions of the function constituent elements (and functions of the memory 12 and auxiliary storage device 13). The electronic circuit may be called processing circuitry as well.

The electronic circuit 16 may be a single circuit, a composite circuit, a programmed processor, a parallel-programmed processor, a logic IC, a Gate Array (GA), an Application Specific Integrated Circuit (ASIC), or a Field-Programmable Gate Array (FPGA).

The functional constituent elements may be implemented by one electronic circuit 16. The functional constituent elements may be implemented by a plurality of electronic circuits 16 by dispersion.

Alternatively, some of the function constituent elements may be implemented by hardware, and the other function constituent elements may be implemented by software.

The processor 11, the memory 12, the auxiliary storage device 13, and the electronic circuit 16 mentioned above are collectively referred to as “processing circuitry”. That is, the functions of the function constituent elements are implemented by processing circuitry.

### Embodiment 2

A difference from the embodiment described above will be described with referring to drawings.

An information generation device 100 according to the present embodiment can share, with another information generation device 100, a data management table 121 managed by another information generation device 100.

***Description of Configurations***

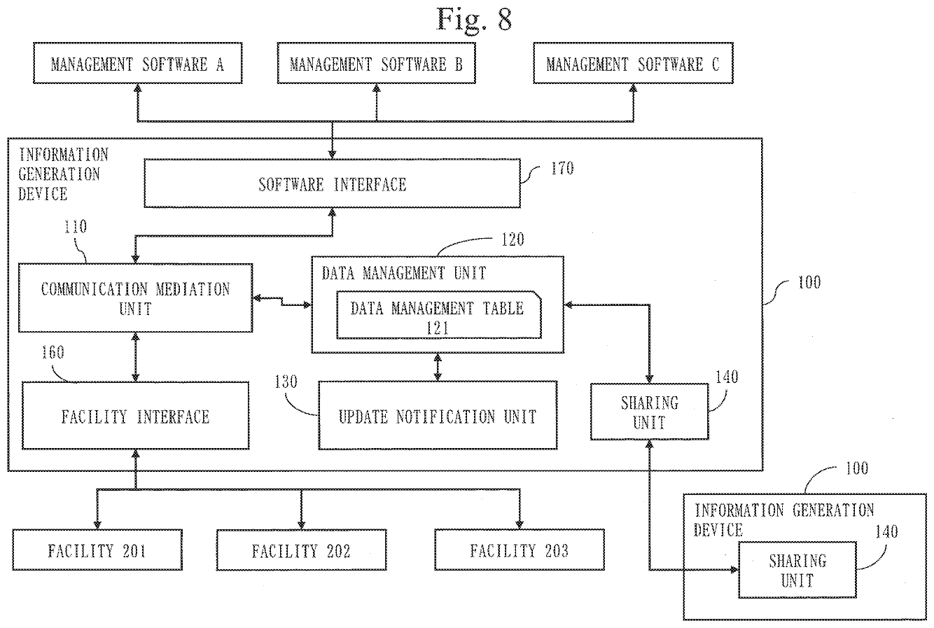

FIG. 8 presents a configuration example of the information generation device 100 according to the present embodiment.

As illustrated in FIG. 8, the information generation device 100 is provided with a sharing unit 140.

When a data management table 121 of a certain information generation device 100 is updated, a sharing unit 140 of that information generation device 100 communicates with a sharing unit 140 of another information generation device 100, so that the updated data management table 121 can be notified to another information generation device 100.

The plurality of information generation devices 100 may be built in a plurality of hardware devices located to be separate from each other and may be connected to each other via a network. The plurality of information generation devices 100 may be built in a cloud environment. The plurality of information generation devices 100 may be built in one server and may be able to communicate with each other via a data bus or the like.

The sharing unit 140 may share the data management table 121 with another sharing unit 140 by directly communicating with another sharing unit 140. The sharing unit 140 may share the data management table 121 with another sharing unit 140 via a database that accumulates the data management table 121.

***Description of Operations***

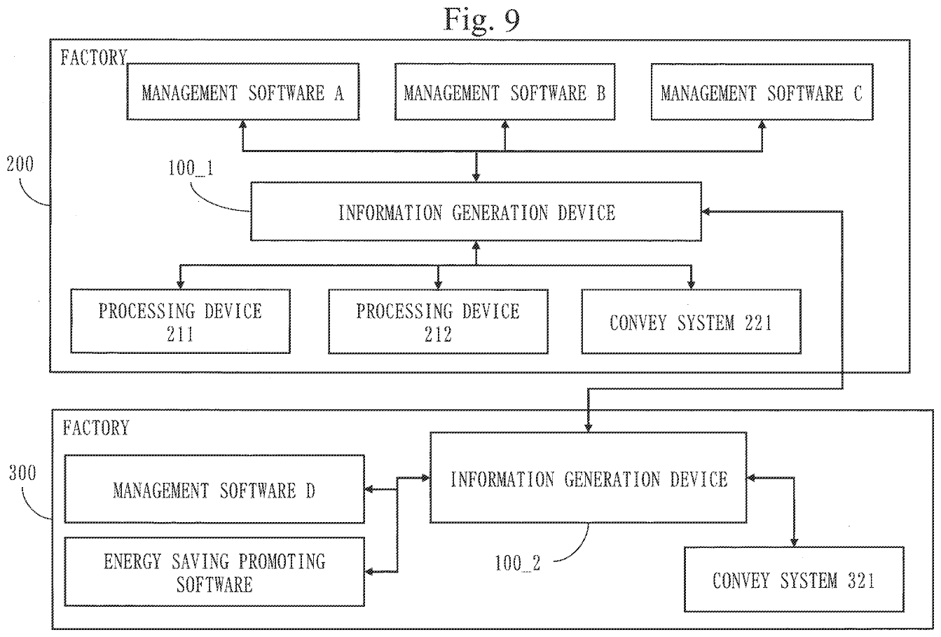

Operations of the information generation device 100 will be described below with referring to an example illustrated in FIG. 9. FIG. 9 presents a configuration example of an information generation system 90 provided with an information generation device 100_1 and an information generation device 100_2 according to the present embodiment. Both the information generation device 100_1 and the information generation device 100_2 are information generation devices 100, and are represented as they are so that the two information generation devices 100 can be distinguished from each other.

In this example, a factory 300 exists in addition to a factory 200. The information generation device 100_2 independent of the information generation device of the factory 200 exists in the factory 300.

In this example, power consumption of a convey system 321 of the factory 300 is monitored by monitoring software D, just as power consumption of the convey system 221 of the factory 200 is. Note that a manager of the convey system 321 installs new energy saving promoting software, and monitors the power consumption.

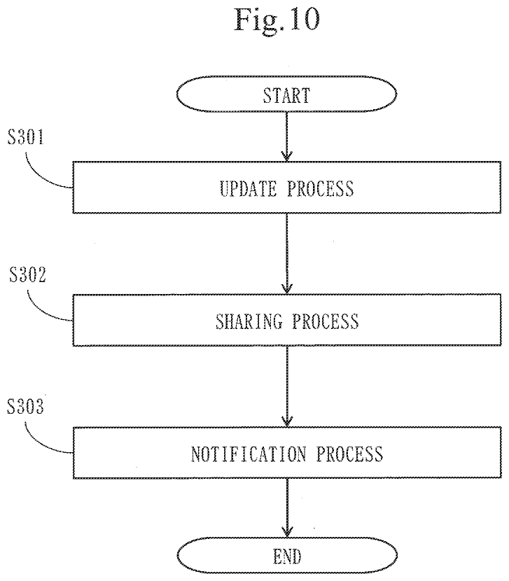

FIG. 10 is a flowchart illustrating an example of the operations of the information generation device 100 in this example.

(Step S301: Update Process)

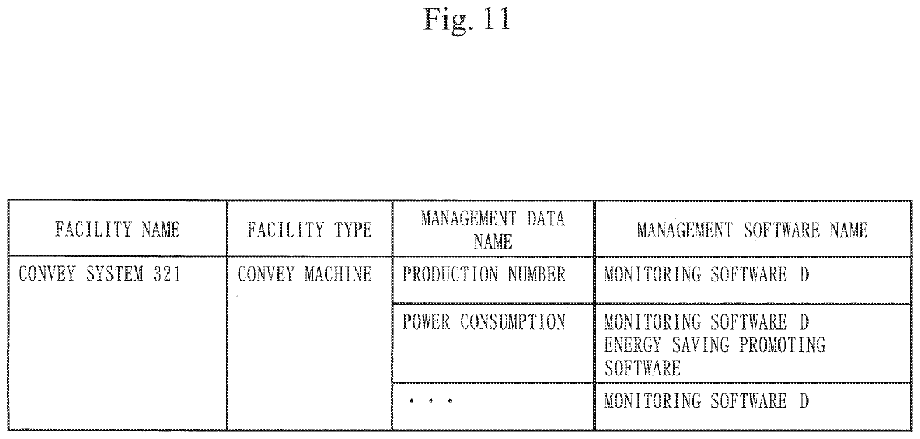

A data management unit 120 of the information generation device 100_2 updates a data management table 121 as illustrated in FIG. 11.

(Step S302: Sharing Process)

A sharing unit 140 of the information generation device 100_2 shares the data management table 121 updated in step S301, with a sharing unit 140 of the information generation device 100_1.

The sharing unit 140 of the information generation device 100_2 may share the updated data management table 121 with the information generation device 100_1 by notifying only differences between before and after update of the data management table 121 to the sharing unit 140 of the information generation device 100_1.

(Step S303: Notification Process)

The update notification unit 130 of the information generation device 100_1 notifies to the manager of the convey system 221 that the energy saving promoting software monitors power consumption of the convey system 321.

### Feature of Embodiment 2

The information generation device 100 is provided with the sharing unit 140 which, when the data management table 121 is updated, shares the updated data management table 121 with another information generation device 100.

The sharing unit 140 shares the updated data management table 121 with a sharing unit 140 of another information generation device 100 by notifying only differences from before and after update to the sharing unit 140 of another information generation device 100.

### Description of Effect of Embodiment 2

As has been described above, according to the present embodiment, even facilities that are located at positions separate from each other can share information of the management software and information of data used by the management software, relatively easily.

Therefore, according to the present embodiment, the plurality of information generation devices 100 can share relatively easily how the management software utilizes data.

<Modification 9>

The sharing units 140 need not share the data management table 121 immediately after the data management table 121 is updated.

According to the present modification, in a specific example, the sharing units 140 do not share the data management table 121 until a predetermined period of time lapses since a time point at which the data management table 121 is shared the last time.

### OTHER EMBODIMENTS

The embodiments described above can be combined arbitrarily. Any constituent element of each embodiment can be modified. In each embodiment, any constituent element can be omitted.

Embodiments are not limited to those indicated as Embodiments 1 and 2, but various modifications can be made in the embodiments as necessary.

### REFERENCE SIGNS LIST

10: computer; 11: processor; 12: memory; 13: auxiliary storage device; 14: data bus; 15: communication IF; 16: electronic circuit; 19: OS; 90: information generation system; 100: information generation device; 110: communication mediation unit; 120: data management unit; 121: data management table; 130: update notification unit; 140: sharing unit; 160: facility interface; 170: software interface; 200: factory; 201: facility; 202: facility; 203: facility; 211: processing device; 212: processing device; 213: processing device; 221: convey system; 300: factory; 321: convey system.

1. An information generation device comprising:
processing circuitry
to mediate communication between a facility and management software that manages the facility,
to store information including a facility type of the facility and a management data name, as the management information to correspond to the facility, the management data name being a name of data of the facility and being used for the management software to manage the facility, and to update the stored management information on a basis of mediated communication, and
to generate update information corresponding to update data, when the stored management information is updated, if same-type facility data corresponding to a same-type facility is stored in the processing circuitry, the same-type facility being a facility of a same type as a facility corresponding to the update data that is updated.

2. The information generation device according to claim 1,
wherein the processing circuitry stores information of a manager of a facility to correspond to the facility, and notifies the update information to a manager of the same-type facility.

3. The information generation device according to claim 2,
wherein if the update data is reflected in the same-type facility data, the processing circuitry does not notify the update information to the manager of the same-type facility.

4. The information generation device according to claim 2,
wherein the processing circuitry stores notification means per manager of the facility, and notifies the update information to the manager of the same-type facility according to the notification means.

5. The information generation device according to claim 1,
wherein the processing circuitry manages the management information with using a data management table.

6. The information generation device according to claim 5,
wherein information of the management software is stored in the processing circuitry, as being included in the management information.

7. The information generation device according to claim 5,
wherein the processing circuitry shares, when the data management table is updated, the updated data management table with another information generation device.

8. The information generation device according to claim 7,
wherein the processing circuitry shares the updated data management table with another processing circuitry by notifying only differences between before and after update, to the processing circuitry of another information generation device.

9. An information generation method comprising:
mediating communication between a facility and management software that manages the facility;
storing information including a facility type of the facility and a management data name, as the management information to correspond to the facility, the management data name being a name of data of the facility and being used for the management software to manage the facility, and updating the stored management information on a basis of mediated communication; and
generating update information corresponding to update data, when the stored management information is updated, if same-type facility data corresponding to a same-type facility is stored, the same-type facility being a facility of a same type as a facility corresponding to the update data that is updated.

10. A non-transitory computer-readable recording medium recorded with an information generation program which causes a computer
to mediate communication between a facility and management software that manages the facility,
to store information including a facility type of the facility and a management data name, as management information to correspond to the facility, the management data name being a name of data of the facility and being used for the management software to manage the facility, and to update the stored management information on a basis of mediated communication, and
to generate update information corresponding to update data, when the stored management information is updated, if same-type facility data corresponding to a same-type facility is stored in the computer, the same-type facility being a facility of a same type as a facility corresponding to the update data that is updated.
